(19) United States
(12) Patent Application Publication
(10) Pub. No.: US 2020/0078862 A1
(43) Pub. Date: Mar. 12, 2020

(54) METHOD OF MANUFACTURING A STRUCTURAL ELEMENT

(71) Applicant: CONSTELLIUM ISSOIRE, Issoire (FR)

(72) Inventors: Jean-Christophe EHRSTROM, Grenoble (FR); Bechir CHEHAB, Voiron (FR)

(21) Appl. No.: 16/466,653

(22) PCT Filed: Dec. 7, 2017
(86) PCT No.: PCT/FR2017/053445

§ 371 Date: Jun. 5, 2019

(30) Foreign Application Priority Data
Dec. 7, 2016 (FR) 1662068

(51) Int. Cl. B22F 3/105; B33Y 10/00

(52) U.S. Cl. CPC B22F 3/1055; B33Y 80/00; B33Y 10/00

(57) ABSTRACT

The invention is a method of manufacturing, from a workpiece, a metallic structural element comprising a skin, from which stringers extend. According to the invention, some of the stringers are obtained by machining, while the others are obtained by addition of material. The material can be added by an additive manufacturing process.

### TECHNICAL FIELD

The technical field of the invention is the manufacture of parts made of metal or metal alloy, in particular aluminum or aluminum alloy.

### PRIOR ART

Aluminum is an element present in many industrial fields, for example the building, food, automobile and aeronautic industries. Because of its lightness, corrosion behavior and ability to be shaped, it is commonly used for the production of structural elements, for example frameworks in buildings or frames or panels for vehicles, for example automobiles or airplanes.

Some structural elements are fuselage panels, having a flat or curved surface, forming a skin, from which protrude stringers, these increasing the rigidity of the panel. In general, the skin and the stringers are manufactured separately, and then the latter are assembled, for example using rivets or bolts. This represents a significant labor cost, as a large number of rivets or bolts needs to be used.

Alternatively, to form such an aluminum structural element, a solid plate, for example of thickness between 30 and 100 mm, can be machined. Machining makes it possible to form both the skin and the stringers. However, such a method, called mass machining, involves removing a large amount of material. The ratio between the quantity of material purchased over the quantity of material actually used is unfavorable, such a ratio being designated in aeronautics by the term buy-to-fly ratio.

Since the 1980s, additive manufacturing techniques have developed, which consist of forming a part by adding material, as opposed to machining techniques, which remove material. Formerly confined to prototyping, additive manufacturing is now operational for manufacturing industrial products in series, including metal parts.

Patent application US20160136891 describes the use of an additive manufacturing process to form the skin of a fuselage. According to this method, a composite skin is formed consisting of two aluminum layers between which is arranged a layer of titanium. After cooling, the skin takes on a curved shape.

Patent application FR1458451 describes a method of manufacturing an airplane fuselage panel, comprising a skin from which stringers extend, the skin and the stringers being made simultaneously by additive manufacturing. Such a method is, however, expensive in terms of material deposition time and hardly compatible with the requirements of a fuselage skin, especially from the standpoint of fatigue behavior and damage tolerance.

In sensitive applications of the aeronautical type, the material composing certain parts of pieces, called critical parts, must be controlled in order to meet precise requirements in terms of mechanical properties. Critical parts include parts of a piece that may be exposed to significant mechanical stress. Additive manufacturing techniques may not meet the mechanical property requirements for critical parts of certain pieces.

The invention meets the limitations of the methods of prior art, and proposes an optimized manufacturing process.

### DISCLOSURE OF THE INVENTION

The first subject of the invention is a method of manufacturing a structural element from a so-called metal base piece, the structural element comprising a skin, extending between an inner surface and an outer surface, and at least one stringer, the stringer extending from the skin, to a distal end, the method comprising the following steps:
a) obtaining a workpiece from the base piece, said base piece being a plate obtained by casting then rolling;
b) machining the workpiece, so as to form:
   a skin, extending between an inner surface and an outer surface;
   at least one stringer blank, extending from the inner surface to a distal end, in a direction of extension secant to the inner surface, the distal end being arranged at a first distance, known as the first extension distance, of the inner surface;
c) addition of material on the end of the stringer blank formed in step b), so as to extend the stringer blank in the direction of extension, in order to obtain a stringer whose distal end extends to a second extension distance of the inner surface, the second extension distance being greater than 1.5 times the first extension distance, the material being added by additive manufacturing, successively adding elementary layers of material.

In this way, in step c), the addition of material displaces the distal end of the stringer blank relative to the inner surface to obtain the stringer.

Skin is taken to mean a slab of flat or curved material delimited by an inner surface and an outer surface, the thickness of the skin being less than 2 cm, or even 1 cm. The inner surface and the outer surface preferably extend parallel to, or substantially parallel to, each other. The term substantially parallel means parallel to a given tolerance, which may be an angular tolerance of ±10° or ±20°.

Extending from the skin means protruding from the skin.

Preferably, at the end of step c), the second extension distance is greater than twice or even three times the thickness of the skin.

Preferably, the first extension distance d₁ may be, for example, between 1 cm and 10 cm or between 1 cm and 5 cm or between 2 cm and 4 cm.

Another subject of the invention is a method of manufacturing a structural element from a so-called metal base piece, the structural element comprising a skin and at least one stringer, the stringer extending from the skin, to a distal end, the method comprising the following steps:
a) obtaining a workpiece from the base piece, said base piece being a plate obtained by casting then rolling;
b) adding material to the workpiece so as to form at least one stringer blank extending from the workpiece to a distal end in a direction of extension secant to said workpiece; the distal end being arranged at a distance, said first extension distance, of said workpiece, material being added by additive manufacturing, successively adding elementary layers of material;
c) machining the workpiece, to thin the workpiece, around the blank formed in step b), the workpiece thus thinned forming a skin, extending between an inner surface and an outer surface, machining having the effect of extending the stringer blank to the inner surface, so as to obtain a stringer whose distal end extends to a second extension distance of the inner surface, the second extension distance being greater than 1.5 times the first extension distance.

Preferably, the difference between the second extension distance and the first extension distance (d2−d1) may be, for example, between 1 cm and 10 cm or between 1 cm and 5 cm or between 2 cm and 4 cm.

The common concept behind these methods is the combination of two techniques for forming a skin, from which one or more stringers extend: a conventional machining technique, of recognized efficiency, making it possible to form a part of each stringer, called proximal, arranged near the skin. Each process combines machining and an additive manufacturing technique, machining being performed either before or after additive manufacturing. The distal end of each stringer is obtained by adding material, prior to machining or after machining. The method can be employed from a thinner base piece than in prior art, in particular by optimizing the amount of material forming the structural element relative to the amount of material forming the base piece. The use of a thinner base piece also allows better control of the mechanical properties, particularly at the parts of the structural element exposed to the greatest stresses, as described below.

Each manufacturing method may include any of the following characteristics, taken separately or in technically feasible combinations:
The workpiece corresponds to the base piece.
Step a) comprises:
   application of a thermomechanical treatment to the base piece or the workpiece; this may be solution heat treatment followed by quenching.
   and/or forming of the base piece. Forming may include deformation to obtain a workpiece of curved shape.
Following step c) the method includes, artificial aging.
During additive manufacturing, the thickness of each elementary layer added successively is preferably between 10 μm and 5 mm.
Following step c), the method comprises a machining step, called finishing machining.
The base piece is made of an alloy based on aluminum or titanium or magnesium.
In the material addition step, the added material is an aluminum or titanium or magnesium alloy.

Another subject of the invention is a structural element, intended for a structure of a construction, characterized in that it is made by using the method described in this application. Another subject of the invention is a vehicle for land, sea, air or even space transport, whose metal structure comprises at least one structural element made according to the method described in this application.

Other advantages and features will emerge more clearly from the description of particular embodiments of the invention, given by way of non-limiting examples, and shown in the figures listed below.

### FIGURES

FIG. 1A shows the main steps of a first embodiment. FIGS. 1B, 1C, 1D and 1E are sections along a plane XZ illustrating the different steps of the first embodiment. FIG. 1F is a diagram of a structural element obtained according to the first embodiment. FIG. 1G is a representative diagram of a material addition method that can be used.

FIG. 2A shows the main steps of a variant of the first embodiment. FIGS. 2B, 2C, 2D and 2E are sections along a plane XZ illustrating the different steps of this variant. FIG. 2F is a diagram of a structural element obtained according to this variant.

FIG. 3A shows the main steps of a second embodiment. FIGS. 3B, 3C and 3D are sections along a plane XZ illustrating the different steps of the second embodiment. FIG. 3E is a diagram of a structural element obtained according to the second embodiment.

FIG. 4A shows the main steps of a variant of the second embodiment. FIGS. 4B, 4C, and 4D are sections along a plane XZ illustrating the different steps of this variant. FIG. 4E is a diagram of a structural element obtained according to this variant.

### DISCLOSURE OF PARTICULAR EMBODIMENTS

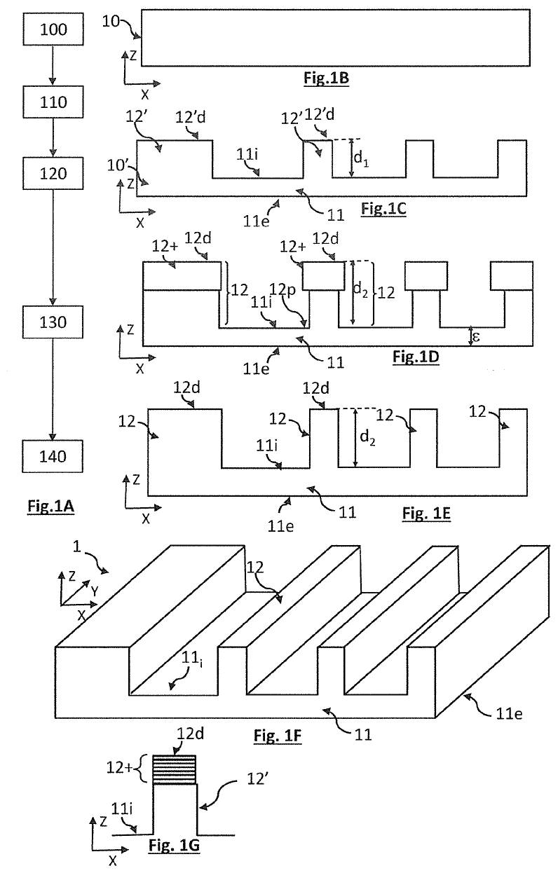

FIG. 1A describes the main steps for manufacturing a panel-type structural element 1, comprising a skin 11 from which stringers 12 protrude, this structural element being shown schematically in FIG. 1F. The term structural element refers to an element intended for mechanical construction, whose properties characteristics are important to guarantee the structural integrity of said construction.

In this example, the structural element 1 is intended for the construction of an aircraft, in particular an airplane. This is a panel intended to form a structural element such as a fuselage, a door, a door frame, a floor, a hatch, a partition, an airplane wing or any other wing element of the tail fin, tail unit, flap or rudder type; this list is not exhaustive. Stringers 12 are intended to endow panel 1 with a certain rigidity and/or a certain mechanical resistance. Stringers 12 may also be designated by the terms spars or ribs. The thickness of skin 11, along a transverse axis Z shown, may range between 0.5 mm, or even 0.8 cm and 1 cm, or even 1.5 cm or 4 cm, while the height of a stringer 12, along the same axis, may range between 1 cm and 10 cm or between 1 cm and 20 cm. In this example, the stringer is rectilinear and extends along the longitudinal axis Y. The dimensions of panel 1, in a plane XY, may be up to 5 m×20 m or more. The example of a rectilinear stringer is a particular, non-limiting example and the invention also applies to obtaining a non-rectilinear stringer. The main steps of the method are as follows:

Step 100 (FIG. 1B): obtaining a base piece 10, in particular a plate, of metal material, for example an aluminum, or titanium or magnesium based alloy. In the next part of the description, the term aluminum designates aluminum or an aluminum alloy, in particular an alloy of the type 2XXX, 5XXX, 6XXX or 7XXX, as defined by The Aluminum Association known to those skilled in the art. The thickness E of the base piece, along the transverse axis Z, is preferably less than 100 mm, and is preferably between 5 mm and 50 mm. The base piece 10 is obtained by rolling. The thickness of the base piece is therefore low, as compared with the manufacturing methods, described in prior art, known as mass machining.

Step 110: obtaining a workpiece 10′ from the base piece 10. During this optional step the base piece 10 obtained after the previous step can be formed and/or have its dimensions adjusted, so as to obtain a workpiece 10′. This step may also comprise a thermomechanical treatment, i.e. a thermal and/or mechanical treatment, comprising in particular, for alloys with age hardening, a solution heat treatment followed by quenching, before a step involving stress relieving by stretching and then aging. Thermomechanical treatment can be applied before or after shaping the base piece 10 or adjusting its dimensions.

Solution heat treatment is a thermomechanical treatment known to those skilled in the art. This treatment involves heating an alloy for a sufficient length of time to allow the precipitates present in the alloy to dissolve so that alloying elements, present in the alloy, are in a solid solution. The solution heat treatment temperature depends on the alloy. A solution heat treatment is followed by quenching, during which the alloy is cooled rapidly, so as to maintain a homogeneous distribution of the alloying elements. Precipitation hardening can be obtained during a subsequent natural or artificial aging or tempering step. The conditions for solution heat treatment, quenching, stress relief and aging are determined by those skilled in the art depending on the alloy and the dimensions of the piece.

The thermomechanical treatment can be performed in successive or separate steps. Advantageously, therefore, the solution heat treatment and quenching steps are carried out during step 110 while aging is carried out at a later stage of the method, as described below.

The method may include no deformation, thermomechanical treatment or dimensional adjustment, in which case the workpiece 10′ corresponds to the base piece 10.

Step 120 (FIG. 1C): machining. The workpiece is machined, the term machining denoting removal of material to form a predetermined shape. It is in particular a turning, milling, boring, electroerosion, grinding, or polishing process. Machining is performed so as to form a skin 11 extending, along the transverse axis Z, between an outer surface lie and an inner surface 11i.

The thickness of the skin is preferably less than 4 cm, 2 cm, or even 1.5 cm or 1 cm. Machining also makes it possible to form at least one stringer blank 12′, extending, along the transverse axis Z, between the inner surface 11i and an end called the distal end 12′d. The distal end 12′d of the stringer blank 12′ extends to a distance d₁, called the first extension distance, from the inner surface 11i. The first extension distance d₁ may for example be between 1 cm and 5 cm, or between 1 cm and 10 cm. In this example, the stringer blank 12′ extends in an direction of extension corresponding to the transverse axis Z, the latter being perpendicular to the inner surface 11i. Another direction of extension secant to the inner surface 11i is possible. Preferably, several stringer blank 12′ are simultaneously formed during this step.

Unlike the method described in application WO2004/056501, the thermomechanical treatments, described in connection with step 110, are not carried out following step 120, i.e. after machining, but nonetheless exhibit the advantage of being made on a thin base piece. In the method according to the invention, therefore, it is not necessary to carry out a stress relieving step on a machined product of complex shape, as described in WO2004/056501, which may prove difficult industrially.

Step 130 (FIG. 1D): addition of material. This step aims to extend the stringer blank 12′, in the direction of extension, so as to move the distal end 12′d of the inner surface 11i further away. At the end of this step, a stringer 12 is obtained, whose distal end 12d extends to a distance d₂ from the inner surface 11i, called the second extension distance, greater than the first extension distance d₁. The second extension distance d₂ may be greater than 1.5 times, or even twice the first extension distance d₁, or even more. Step 130 may lead to an increase in the extension distance by more than 10 mm or even more than 30 mm. In other words, d₂≥d₁+10 mm, or d₂≤d₁+30 mm. The amount of added material 12+ is therefore preferably greater than 10 mm, or even greater than 30 mm. At the end of this step, each stringer 12 formed extends between a proximal end 12p, in contact with the inner surface 11i, and the distal end 12d formed by the addition of material.

Material is added by additive manufacturing, as shown in FIG. 1G, from a previously established digital model. The term additive manufacturing is defined according to French standard XP E67-001: “set of methods for making a physical object from a digital object by adding material, layer by layer”. Standard ASTM F2792-10 also defines additive manufacturing. Different additive manufacturing means are also defined and described in standard ISO/ASTM 17296-1. The use of additive manufacturing to produce an aluminum part with low porosity was described in document WO2015006447. Successive layers, called elementary layers, may be applied by applying a filler material on end 12d, and then melting or sintering the filler material using a source of energy of the laser beam, electron beam, plasma torch or electric arc type. The filler material may be in the form of a powder or wire, or a rod or a strip. The publication Gu J. “Wire+Arc Additive Manufacturing of Aluminum” Proc. 25th Int. Solid Freeform Fabrication Symp., August 2014, University of Texas, 451-458, describes an example of applying an additive manufacturing method referred to as WAAM, an acronym for “Wire+Arc Additive Manufacturing”, to aluminum alloys to make low porosity parts for the aeronautical field. Other methods that can be used include, for example, and without limitation, melting or sintering of a filler material in the form of a powder. This may be laser melting or laser sintering. The Swedish company Arcam has developed an additive manufacturing process of the electron beam melting type for the production of aeronautical components, for example turbine blades. The publication T. Mahale, “Advances in Electron Beam melting of Aluminum Alloy,” Proceedings of Solid Freeform Fabrication Symposium 2007, Austin, Tex., describes the application of electron beam melting to aluminum alloys to make parts for aeronautics. Another known additive manufacturing method is friction stir additive manufacturing. This method is, for example, described in Puleo, Shawn Michael, “Additive Friction Stir Manufacturing of 7055 Aluminum Alloy” (2016). Senior Honors Theses. Paper 75, or in document US2014/0134325.

Whatever the additive manufacturing method applied, the thickness of each elemental layer added is typically at least of the order of 10 microns and may also range up to few millimeters, for example 5 mm. An additional piece 12+ is then gradually formed, layer by layer, on the stringer blank 12′.

The different elementary layers may consist of the same material. According to one variant, the elementary layers do not consist of the same material; the material constituting an elementary layer may vary from one elementary layer to another. Each elemental layer may be of the same thickness. According to one variant, elementary layers may be of different thicknesses.

Step 130 may also include thermomechanical treatment following the addition of material. This may be, for example, deformation by compression, for example hot isostatic compression. This makes it possible to fill pores formed during the addition of material.

Step 140 (FIG. 1E): Finish. This step may comprise finishing machining of the piece obtained following step 130, so as to obtain a surface condition compatible with the intended end use. According to one variant, step 140 may include an aging step before or, preferably, after finishing machining.

The method does not require the use of a very thick base piece 10, compared to the methods of prior art in which the skin 11 and the stringers 12 are mass machined from the same base piece. According to the invention, the base piece must have a thickness, along the transverse axis Z, greater than or equal to the thickness of skin 11 plus the thickness of the stringer blank 12′, i.e., the thickness of skin 11 and of the first extension distance d₁. This gives an improvement to the buy-to-fly ratio mentioned previously. The thickness of the base piece 10 may be reduced by a factor greater than or equal to 2. For example, to manufacture a panel whose total thickness is 70 mm, using a mass-machining method from prior art, a base piece with a thickness of about 75 mm is used. By using the invention, the thickness of the base piece can be reduced to 30 mm, instead of 75 mm, a gain in thickness of 45 mm. The total thickness of 70 mm corresponds to the thickness E of skin 11 plus the height of the stringers, i.e. the second extension distance d₂ described above.

Another advantage of using a thinner base piece is related to the influence of the thermomechanical treatment on the mechanical properties. The thermomechanical treatment, regardless of whether it is applied during step 110 or following step 120, or during step 140, is performed on a workpiece whose thickness is reduced with respect to prior art. It is known that the efficiency of thermomechanical treatment is limited by the thickness of the part treated, insofar as lower quenching speeds are obtained on thicker parts. The application of a thermomechanical treatment on a thinner part makes it easier to obtain more advantageous mechanical properties. These mechanical properties are also more predictable because they are less subject to fluctuations related to thermal diffusion. In addition, this reduces the length of the thermomechanical treatment, which increases the efficiency of the method and reduces the related costs. The mechanical properties are thus controlled, in particular at the most critical parts of the piece, corresponding to skin 10 or the interface between skin 10 and stringers 12 (i.e. at the proximal end 12p of the stringers), on which mechanical stresses may be great. If material was deposited directly on the skin, the junction between the skin and the added stringer would be located at a critical part from the standpoint of fatigue behavior, in particular.

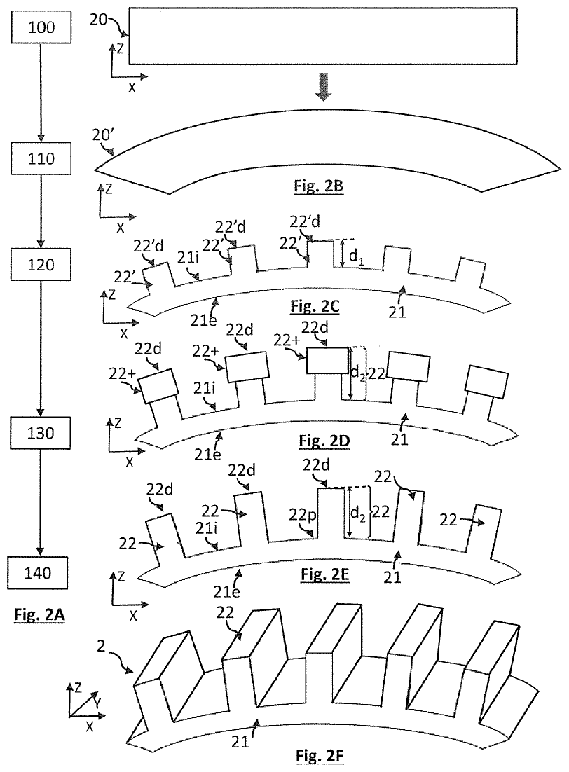

Another consequence of reducing the thickness of the base piece is that the latter is easier to shape, as illustrated in a variant of the first embodiment, described below, with reference to FIGS. 2A to 2F. The objective is to obtain a structural element 2 whose skin is not flat, but fits a curved shape, for example by being curved, as shown schematically in FIG. 2F. Such a shape can be adapted to a fuselage, a door frame or a wing element. Steps 100 to 150 of this variant are similar to steps 100 to 150 respectively, previously described. The main difference is that the method comprises, in step 110, a deformation of the base piece, so that it matches the predefined curved shape. It has been calculated that the force to be applied to deform a piece of thickness 30 mm may be significantly lower than that required to obtain a similar deformation of a piece of thickness 75 mm. The gain obtained may be greater than 5 or 6, i.e. the force exerted to obtain the deformation is at least 5 or 6 times lower.

From a base piece 20 (step 100), a deformation step is applied (step 110—FIG. 2B) so as to obtain a curved workpiece 20′. The following steps are then implemented:
Step 120 (FIG. 2C): machining, so as to form a curved skin 21 extending, along the transverse axis Z, between an outer surface (or outer skin) 21e and an inner surface (or inner skin) 21i. Machining also makes it possible to form at least one stringer blank 22′, extending, in a direction of extension perpendicular to the inner surface 21i, between said inner surface 21i and an end known as the distal end 22′d. The distal end 22′d of the stringer blank 22′ extends to a distance d₁, called the first extension distance, from the inner surface 21i.
Step 130 (FIG. 2D): addition of material 22+ to extend the stringer blank 22′, in the direction of extension, so as to move the distal end 22′d of the inner surface 21i further away. At the end of this step, a stringer 22 is obtained, whose distal end 22d extends to a distance d₂ from the inner surface 21i, called the second extension distance, greater than the first extension distance d₁. This step is identical to that described in connection with FIG. 1D. Stringer 22 has a proximal end 22p in contact with the inner surface 21i.
Step 140 (FIG. 2E): finishing machining, in a manner identical to that described with reference to FIG. 1E.

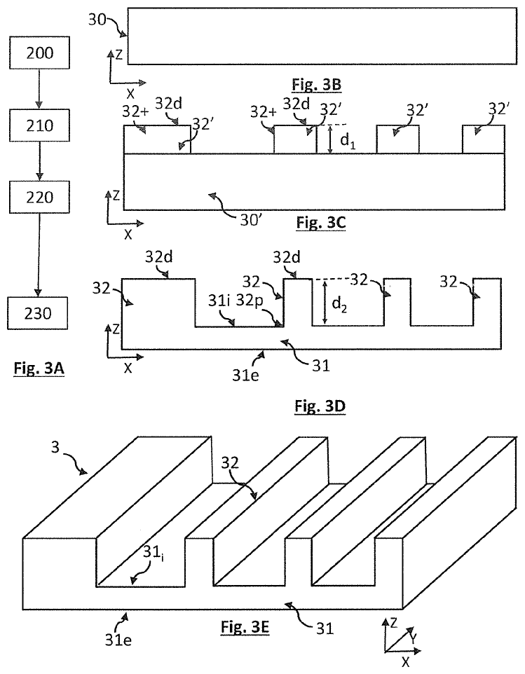

FIG. 3A represents a second embodiment, aimed at obtaining a panel 3 as shown in FIG. 3E, the latter being identical to that shown in FIG. 1F. According to this third embodiment, the method comprises the following steps:
Step 200 (FIG. 3B): obtaining a base piece 30, as described in connection with step 100 of the first embodiment.
Step 210: treatment of the base piece 30, so as to obtain a workpiece 30′, identical to step 110 of the first embodiment. This step may comprise a deformation, an adjustment of the dimensions or the thermomechanical treatments previously described, in connection with step 110.
Step 220 (FIG. 3C): adding material 32+ to workpiece 30′. This step makes it possible to form a stringer blank 32′ extending, along the transverse axis Z, between the workpiece 30′ and an end, known as the distal end 32d. The distal end of the stringer blank 32d extends to a distance d₁, called the first extension distance, of workpiece 30′. The first extension distance d₁ may for example be between 1 cm and 5 cm to 10 cm. In this example, the stringer blank 32′ extends in an direction of extension corresponding to the transverse axis Z, the latter being perpendicular to the inner surface 31i. Another direction of extension, secant to the inner surface 31i is possible. Material is added according to one of the methods described in step 120.
Step 230 (FIG. 3D): machining workpiece 30′, around each stringer blank 32′ formed in step 220 so as to thin the workpiece and form a skin 31 extending between an outer surface 31e and an inner surface 31i. The thickness of the skin 31 is less than 2 cm, or even 1.5 cm or 1 cm. When, in step 220, several stringer blanks are formed, workpiece 30′ is machined between two adjacent blanks. Machining makes it possible to extend each blank 32′ of stringer 32 to the inner surface 31i of the skin. The extension of each blank 32′ makes it possible to form a stringer 32 extending a proximal end 32p, at the inner surface 31i, and a distal end 32d. The distal end 32d of stringer 32 is identical to the distal end of the blank 32′ corresponding thereto. The distance between the distal end 32d and the inner surface 11i, known as the second extension distance d₂, is greater than the first extension distance d₁. In common with the first embodiment, the second extension distance d₂ is greater than 1.5 times, or even twice the first extension distance d₁, or even more. Step 230 may lead to an increase in the extension distance by more than 10 mm or even more than 30 mm. The second extension distance corresponds to the height of the stringer.

The method may include finishing machining, so as to improve the surface condition of the piece obtained. It may also undergo aging before or after finishing machining.

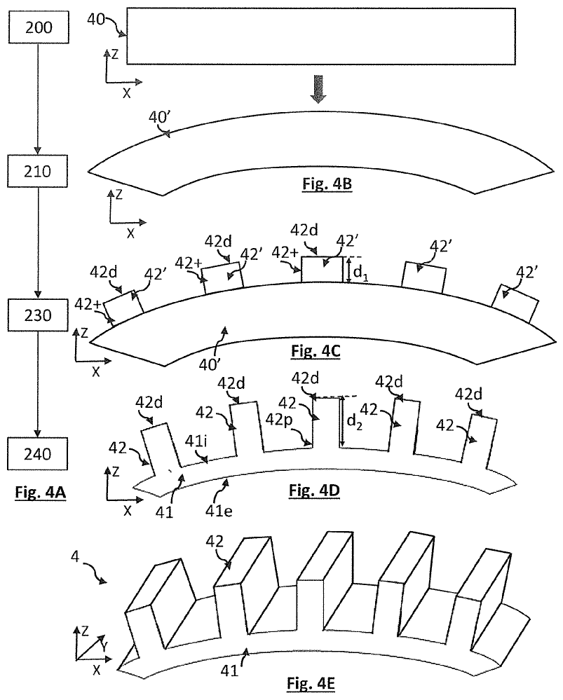

FIG. 4A shows the main steps of a variant of the second embodiment, making it possible to obtain a curved panel 4, as shown in FIG. 4E. The main difference with the third embodiment lies in step 210, during which a base piece 40 is deformed so as to obtain a workpiece 40′ conforming to a predetermined shape, in this case a curved shape (FIG. 4B). The other steps are similar:
Step 220 (FIG. 4C): this step is similar to step 220 previously described. It includes the formation of stringer blanks 42′ by adding material 42+ to workpiece 40′, the distance between the distal end 42d of each blank 42′ and the workpiece being a first extension distance of extension d₁. The extension direction is perpendicular to the surface of the base piece 40′ on which the stringer blanks are formed.
Step 230 (FIG. 4D): this step is similar to step 230 previously described. It comprises machining of base piece 40′, so as to form a skin 41, extending between an outer surface 41e and an inner surface 41i. This extends the stringer blanks 42′ to the skin 41. The extension of each blank 42′ makes it possible to form a stringer 42 extending a proximal end 42p, at the inner surface 41i, and a distal end 42d. The distal end 42d of stringer 42 is identical to the distal end of blank 42′ corresponding thereto. The distance between the distal end 42d and the inner surface 41i, known as the second extension distance d₂, is greater than the first extension distance d₁.

The method may include finishing machining, so as to improve the surface condition of the piece obtained. It may also undergo aging before or after finishing machining.

The invention can be used to produce structural elements for buildings or vehicles, for land, sea or air transport, and in particular in the manufacture of structural elements for fuselages or aircraft wings. It is in particular intended to be used to produce structural elements made of aluminum or aluminum alloy, from an aluminum base piece, the additional material added during the addition step being also aluminum or an aluminum alloy.

1. A method of manufacturing a structural element from a metal base piece, the structural element comprising a skin and at least one stringer, the stringer extending from the skin to a distal end, the method comprising:
a) obtaining a workpiece from the base piece, said base piece being a plate obtained by casting then rolling;
b) machining the workpiece, to form:
a skin, extending between an inner surface and an outer surface;
at least one stringer blank, extending from the inner surface to a distal end, in a direction of extension secant to the inner surface, the distal end being arranged at a first distance (d₁), comprising a first extension distance, of the inner surface;
c) adding material on an end of the stringer blank formed in b), so as to extend the stringer blank in a direction of extension, in order to obtain a stringer comprising a distal end that extends to a second extension distance (d₂) of an inner surface, the second extension distance (d₂) being greater than 1.5 times the first extension distance (d₁), the material being added by additive manufacturing, successively adding layers of material.

2. A method of manufacturing a structural element from a metal base piece, the structural element comprising a skin and at least one stringer, the stringer extending from the skin to a distal end, the method comprising:
a) obtaining a workpiece from a base piece, said base piece being a plate obtained by casting then rolling;
b) adding material to the workpiece to form at least one stringer blank extending from the workpiece to a distal end in a direction of extension secant to said workpiece; the distal end being arranged at a distance (d₁), comprising a first extension distance, of said workpiece, material being added by additive manufacturing, successively adding layers of material;
c) machining the workpiece, to thin the workpiece, around the blank formed in b), the workpiece thus thinned forming a skin, extending between an inner surface and an outer surface, machining having an effect of extending the stringer blank to the inner surface to obtain a stringer comprising a distal end that extends to a second extension distance (d₂) of the inner surface, the second extension distance d₂) being greater than 1.5 times the first extension distance (d₁).

3. Manufacturing method according to claim 1, wherein the workpiece corresponds to the base piece.

4. Manufacturing method according to claim 1, wherein a) comprises:
applying a thermomechanical treatment to the base piece or to the workpiece;
and/or forming the base piece.

5. Manufacturing method according to claim 4, wherein the shaping comprises deformation to obtain a workpiece of curved shape.

6. Manufacturing method according to claim 4, wherein the thermomechanical treatment comprises solution heat treatment followed by quenching.

7. Manufacturing method according claim 1, further comprising aging, following c).

8. Manufacturing method according to claim 1, further comprising, finishing machining following c).

9. Manufacturing method according to claim 1, wherein each layer of successively added material has a thickness of between 10 microns and 5 mm.

10. Manufacturing method according to claim 1, wherein the base piece is an alloy based on aluminum or titanium or magnesium and in which, during material addition, the added material is an alloy of aluminum or titanium or magnesium.

11. Structural element, intended for a structure for a construction, produced using the method of claim 1.

12. Vehicle, the metal structure of which comprises at least one structural element made using the method according to claim 1, the vehicle being intended for land, sea or air or spatial transport.
